(19) United States
(12) Patent Application Publication
(10) Pub. No.: US 2024/0331313 A1
(43) Pub. Date: Oct. 3, 2024

(54) AR CONTENT DISPLAY SYSTEM AND NON-TRANSITORY COMPUTER READABLE MEDIUM

(71) Applicant: FUJIFILM Business Innovation Corp., Tokyo (JP)

(72) Inventor: Takaki TSUCHIYA, Kanagawa (JP)

(73) Assignee: FUJIFILM Business Innovation Corp., Tokyo (JP)

(21) Appl. No.: 18/455,647

(22) Filed: Aug. 25, 2023

(30) Foreign Application Priority Data
Mar. 27, 2023 (JP) 2023-050280

(51) Int. Cl. G06T 19/00; G06T 19/20; G06V 10/25; G06V 10/44

(52) U.S. Cl. CPC G06T 19/006; G06T 19/20; G06V 10/25; G06V 10/44; G06T 2219/2004

(57) ABSTRACT

An augmented reality (AR) content display system includes one or more processors configured to acquire feature points in a nearby region in which guide information for displaying an AR content is pasted, and display the region in which the feature points are acquired and the AR content in association with each other.

### CROSS-REFERENCE TO RELATED APPLICATIONS

This application is based on and claims priority under 35 USC 119 from Japanese Patent Application No. 2023-050280 filed Mar. 27, 2023.

### BACKGROUND

### (i) Technical Field

The present disclosure relates to an augmented reality (AR) content display system and a non-transitory computer readable medium.

### (ii) Related Art

In recent years, AR technologies to display information prepared through data processing as superposed on the real world have been put into practical use. For example, a technology to read a QR code (registered trademark) and display a corresponding AR content is known.

Japanese Unexamined Patent Application Publication No. 2014-142770 describes an augmented reality display device that reads a QR code and display an AR content, the device addressing an issue that the AR content is not displayed when the QR code goes out of an imaging range. The device described in Japanese Unexamined Patent Application Publication No. 2014-142770 enables the AR content to be displayed even when the QR code is in a range in which an information code may not be imaged, by preparing a mirror.

### SUMMARY

In order to display an AR content by reading guide information such as a QR code and an AR marker using an imaging device, it is necessary that the guide information should be imaged. In order to display an AR content, meanwhile, it is necessary to paste the guide information to a work target object. Therefore, it is necessary to take the trouble of pasting guide information, peeling off the guide information, and pasting the guide information to another target object for each work.

Aspects of non-limiting embodiments of the present disclosure relate to reducing the trouble of work to prepare guide information when guide information for displaying an AR content is read to display the AR content.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an augmented reality (AR) content display system including one or more processors configured to acquire feature points in a nearby region in which guide information for displaying an AR content is pasted, and display the region in which the feature points are acquired and the AR content in association with each other.

### BRIEF DESCRIPTION OF THE DRAWINGS

An exemplary embodiment of the present disclosure will be described in detail based on the following figures, wherein:

FIG. 1 illustrates an example of the configuration of an AR content display system according to the present exemplary embodiment;

FIG. 2 illustrates an example of the hardware configuration of a computer that is used as user terminals and a management server;

FIG. 3 illustrates an example of the functional configuration of the management server according to the present exemplary embodiment;

FIGS. 4A to 4C indicate an example of information to be stored in an AR content target management storage unit, in which FIG. 4A indicates a list of AR contents, FIG. 4B indicates a list of AR content display information, and FIG. 4C indicates a list of information associated with guide information;

FIG. 5 is a flowchart illustrating an example of the flow of a process of extracting feature points;

FIGS. 6A and 6B illustrate an example of a process of specifying a region with the largest number of extracted feature points, in which FIG. 6A illustrates an example in which a nearby region around guide information is searched for a region with the largest number of extracted feature points and FIG. 6B illustrates a region specified as the region with the largest number of feature points;

FIG. 7 is a flowchart illustrating an example of the flow of a process of associating a specified region and an AR content;

FIG. 8 is a flowchart illustrating an example of the flow of a process of recognizing a real space marker; and

FIG. 9 is a flowchart illustrating an example of the flow of a process of displaying an AR content.

### DETAILED DESCRIPTION

An exemplary embodiment of the present disclosure will be described in detail below with reference to the accompanying drawings.

### <Configuration of AR Content Display System>

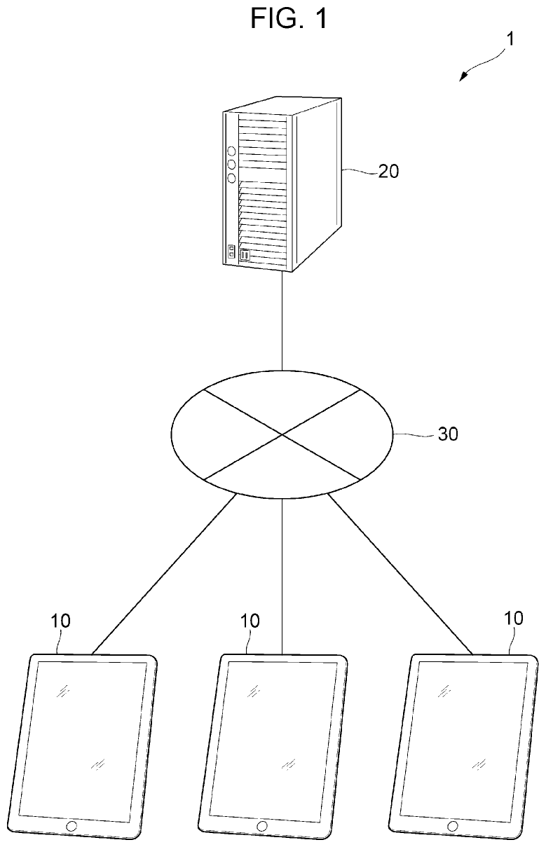

FIG. 1 illustrates an example of the configuration of an AR content display system according to the present exemplary embodiment.

An AR content display system 1 includes user terminals 10 and a management server 20. The user terminals 10 and the management server 20 are connected to each other via a network 30.

The user terminal 10 is an information processing apparatus device that is used by a user to use an AR content. The user terminal 10 images a target object to which guide information has been pasted, and transmits visual data on a nearby region around the guide information to the management server 20. The guide information is a mark for displaying an AR content such as an AR marker or a QR code. For example, when guide information is recognized when a target object is imaged using a terminal etc., an AR content correlated with the guide information is displayed as superimposed on a screen in which the target object is imaged. Then, the user terminal 10 receives an instruction from the management server 20, and displays the instruction on the screen. In addition, the user terminal 10 displays the AR content on the screen in which the target object is imaged.

The user terminal 10 is implemented by a computer, a tablet information terminal, and other information processing devices, for example. Alternatively, the user terminal 10 may be a glasses-type terminal such as a head mounted display (HMD).

The management server 20 receives visual data transmitted from the user terminal 10, and acquires feature points in a nearby region in which guide information is pasted. Then, the management server 20 associates the region in which feature points are acquired and the AR content. Hereinafter, a region to be associated with an AR content will occasionally be referred to as a “real space marker”. When the management server 20 recognizes a real space marker, the management server 20 causes the user terminal 10 to display an AR content associated with the real space marker.

The management server 20 is implemented by a computer, for example. The management server 20 may be constituted by a single computer, or may be implemented through distributed processing by a plurality of computers.

The network 30 is an information communication network that allows communication between the user terminals 10 and the management server 20. The type of the network 30 is not specifically limited as long as the network 30 enables data transmission and reception, and the network 30 may be the Internet, a local area network (LAN), a wide area network (WAN), etc., for example. A communication line that is used for data communication may be wired or wireless. The devices may be connected to each other via a plurality of networks or communication lines.

### <Hardware Configuration of Computer>

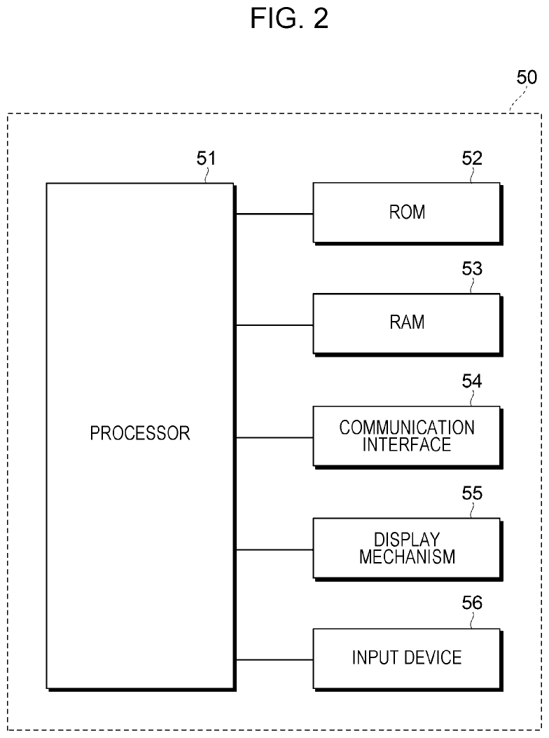

FIG. 2 illustrates an example of the hardware configuration of a computer that is used as the user terminals 10 and the management server 20. A computer 50 includes a processor 51, a read only memory (ROM) 52, and a random access memory (RAM) 53. The processor 51 is a central processing unit (CPU), for example, and uses the RAM 53 as a work area and executes a program read from the ROM 52. The computer 50 also includes a communication interface 54 for connection to a network and a display mechanism 55 for display output on a display. The computer 50 also includes an input device 56 that is used by an operator of the computer 50 to perform an input operation. The configuration of the computer 50 illustrated in FIG. 2 is merely exemplary, and the computer that is used in the present exemplary embodiment is not limited to the configuration example in FIG. 2.

Various processes executed in the present exemplary embodiment are executed by one or more processors.

### <Functional Configuration of Management Server>

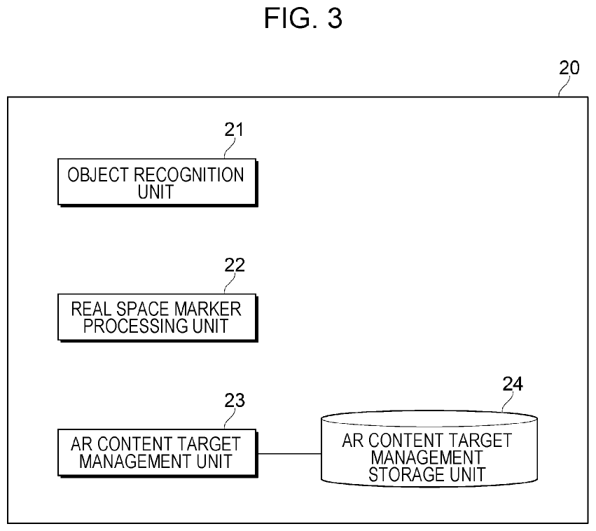

Next, the functional configuration of the management server 20 will be described. FIG. 3 illustrates an example of the functional configuration of the management server 20 according to the present exemplary embodiment.

As illustrated in FIG. 3, the management server 20 includes an object recognition unit 21, a real space marker processing unit 22, an AR content target management unit 23, and an AR content target management storage unit 24.

Functions of the management server 20 may be executed in a distributed manner by a plurality of servers.

The object recognition unit 21 acquires visual data from the user terminal 10, and recognizes guide information. In addition, the object recognition unit 21 extracts feature points in a nearby region in which the guide information is pasted.

The real space marker processing unit 22 acquires the result of extraction of feature points by the object recognition unit 21, and evaluates whether or not the region in which the feature points are extracted is usable as a real space marker. In addition, the real space marker processing unit 22 calculates and corrects misregistration between the pasted guide information and the real space marker.

The AR content target management unit 23 stores, in the AR content target management storage unit 24, information on the real space marker and information on the correlation between an AR marker and the real space marker, misregistration between the AR marker and the real space marker, etc. In addition, the AR content target management unit 23 acquires necessary information from the AR content target management storage unit 24 in accordance with an instruction received from the user terminal 10, and transmits the information to the user terminal 10.

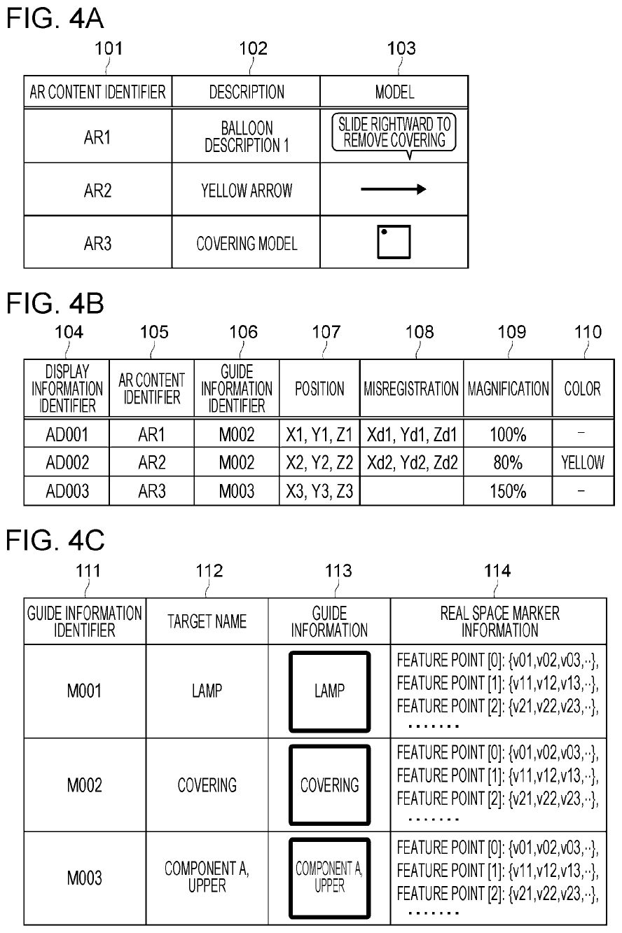

The AR content target management storage unit 24 stores information on the real space marker and information on the correlation between the AR marker and the real space marker, misregistration between the AR marker and the real space marker, etc. The information to be stored in the AR content target management storage unit 24 will be described with reference to FIG. 4. FIGS. 4A to 4C indicate an example of information to be stored in the AR content target management storage unit 24, in which FIG. 4A indicates a list of AR contents, FIG. 4B indicates a list of AR content display information, and FIG. 4C indicates a list of information associated with guide information.

FIG. 4A indicates a list of AR contents. The AR content target management storage unit 24 stores an AR content identifier 101, an AR content description 102, and an AR content model 103 in association with each other. For example, an AR content identifier “AR1” is associated with an AR content description “balloon description 1” and a balloon model saying “slide rightward to remove covering” indicated in FIG. 4A.

FIG. 4B indicates a list of AR content display information. The AR content target management storage unit 24 stores a display information identifier 104 for an AR content, an AR content identifier 105, a guide information identifier 106, a position 107 at which the AR content is displayed, misregistration 108 between guide information and a real space marker, a magnification 109 at which the AR content is displayed, and a color 110 in which the AR content is displayed, in association with each other. For example, a display information identifier “AD002” is associated with an AR content identifier “AR2”, a guide information identifier “M002”, a position “X2, Y2, Z2” at which the AR content is displayed, misregistration “Xd2, Yd2, Zd2” between guide information and a real space marker, a magnification “80%” at which the AR content is displayed, and a color “yellow” in which the AR content is displayed.

FIG. 4C indicates a list of information associated with guide information. The AR content target management storage unit 24 stores a guide information identifier 111, a target name 112, guide information 113, and real space marker information 114 in association with each other. For example, a guide information identifier “M001” is associated with a target name “lamp”, guide information on the lamp indicated in FIG. 4C, and information on feature points of the real space marker indicated in FIG. 4C.

### <Extraction of Feature Points>

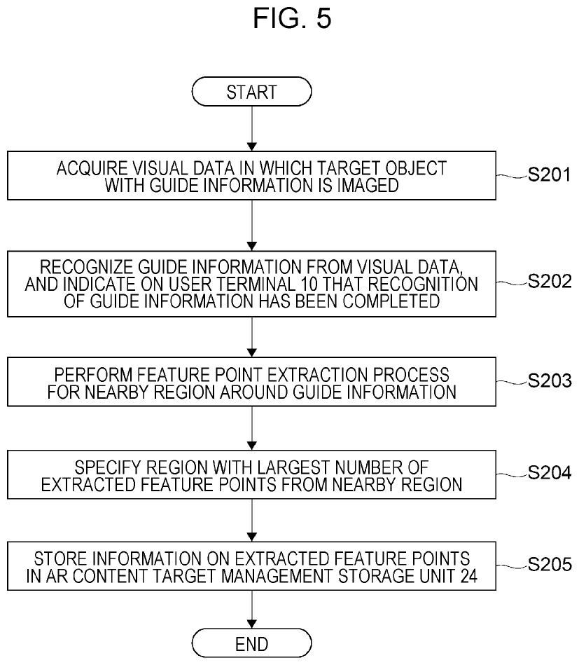

Next, the flow of a process of extracting feature points will be described with reference to FIG. 5. FIG. 5 is a flowchart illustrating an example of the flow of a process of extracting feature points.

In FIG. 5, first, the object recognition unit 21 acquires visual data in which a target object with guide information is imaged (step S201). In step S201, the object recognition unit 21 acquires visual data on a target object imaged by the user terminal 10, for example. The visual data may be a moving image, or may be a still image.

Next, the object recognition unit 21 recognizes guide information from the visual data, and indicates on the user terminal 10 that recognition of guide information has been completed (step S202). Next, the object recognition unit 21 performs a feature point extraction process for a nearby region around the guide information (step S203). The feature point extraction is performed using a conventional technique such as scale invariant feature transform (SIFT), for example.

The nearby region in which the feature point extraction process is performed is a region in a range determined in advance around the position at which the guide information is pasted, for example. The region in the range determined in advance is a region in which the presence of the target object to which the guide information is pasted may be recognized. That is, when a region that is usable as a real space marker is specified from the region in the range determined in advance, it is necessary that the target object may be recognized at the same time when the real space marker is recognized. The nearby region may be a region in a range imaged when the guide information is imaged.

Next, the real space marker processing unit 22 specifies a region with the largest number of extracted feature points from the nearby region (step S204). The process performed in step S204 will be discussed in detail later. Then, the object recognition unit 21 stores information on the extracted feature points in the AR content target management storage unit 24 (step S205).

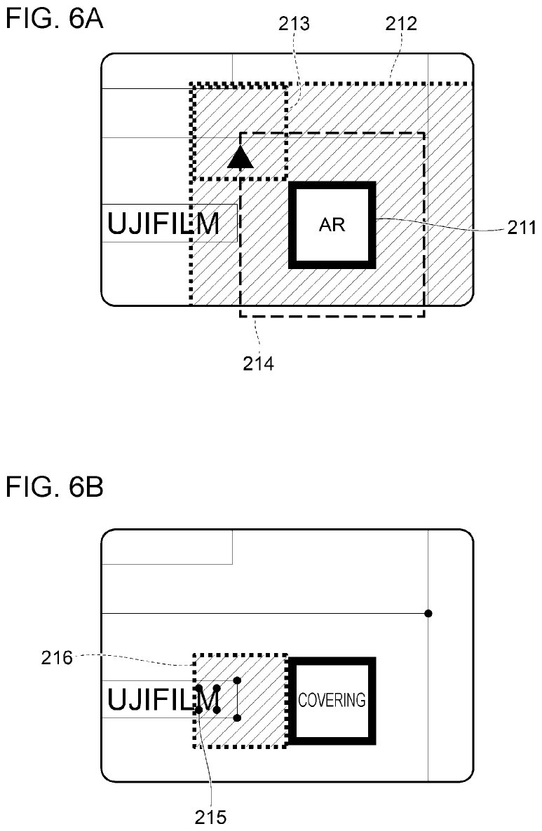

The process performed in step S204 in FIG. 5 will be described with reference to FIGS. 6A and 6B. FIGS. 6A and 6B illustrate an example of a process of specifying a region with the largest number of extracted feature points, in which FIG. 6A illustrates an example in which a nearby region around guide information is searched for a region with the largest number of extracted feature points and FIG. 6B illustrates a region specified as the region with the largest number of feature points.

The object recognition unit 21 extracts feature points for a nearby region 212 around guide information 211 pasted to a target object. As illustrated in FIG. 6B, feature points 215 are extracted inside the region 212. Then, the real space marker processing unit 22 specifies a region with the largest number of extracted feature points from the nearby region. The real space marker processing unit 22 moves a region 213 in a range determined in advance along an arrow 214 in the nearby region 212, and specifies a region with the largest number of feature points included in the region 213 in the range determined in advance. In the example illustrated in FIG. 6B, a region 216 is specified as a region that includes the largest number of feature points 215.

### <Registration of Real Space Marker>

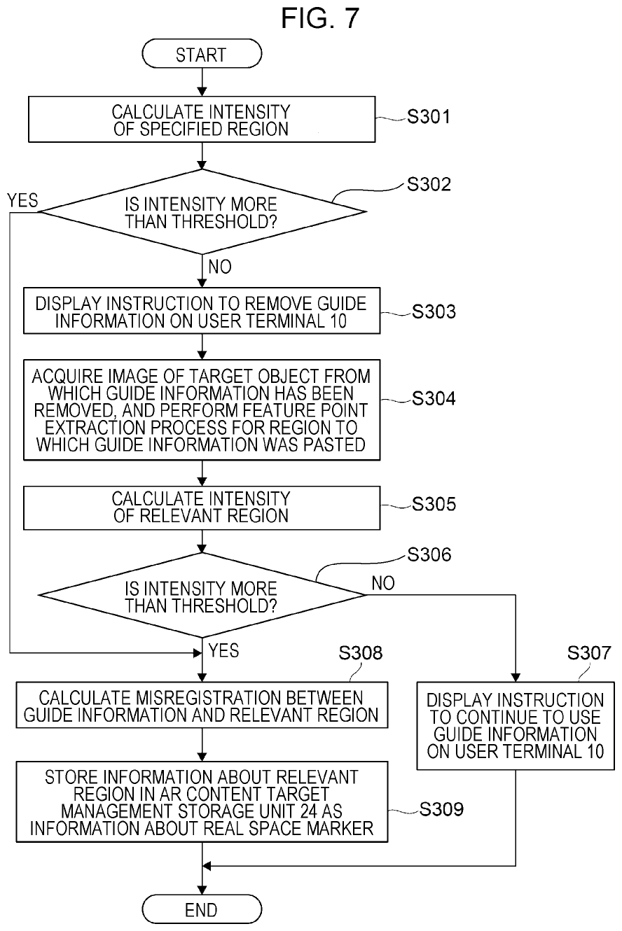

Next, the flow of a process of associating a specified region and an AR content will be described with reference to FIG. 7. FIG. 7 is a flowchart illustrating an example of the flow of a process of associating a specified region and an AR content.

In FIG. 7, first, the real space marker processing unit 22 calculates an intensity of the specified region (step S301). In step S301, the real space marker processing unit 22 calculates the number of feature points as the intensity, for example. In the example illustrated in FIG. 6B, the region 216 includes six feature points 215, and has an intensity of 6.

Next, the real space marker processing unit 22 determines whether or not the intensity is more than a threshold (step S302). In step S302, the real space marker processing unit 22 determines whether or not the region to which guide information is pasted is usable as a real space marker. The real space marker processing unit 22 makes a comparison between the calculated intensity and a threshold determined in advance. When the threshold is determined as 5, for example, it is determined that the intensity of the region 216 is more than the threshold in the example in FIG. 6B.

When the calculated intensity is more than the threshold (YES in step S302), the process proceeds to step S308. When the calculated intensity is not more than the threshold (NO in step S302), on the other hand, the object recognition unit 21 displays an instruction to remove the guide information on the user terminal 10 (step S303). In step S303, the object recognition unit 21 displays on the user terminal 10 a message saying “No region with necessary intensity was detected. Please peel off guide information and extract feature points again”, for example.

Next, the object recognition unit 21 acquires an image of the target object from which the guide information has been removed, and performs a feature point extraction process for the region to which the guide information was pasted (step S304). Next, the object recognition unit 21 calculates an intensity of the relevant region (step S305). Next, the real space marker processing unit 22 determines whether or not the intensity is more than the threshold (step S306). In step S306, the real space marker processing unit 22 determines whether or not the region to which guide information was pasted is usable as a real space marker.

When the calculated intensity is more than the threshold (YES in step S306), the process proceeds to step S308. When the calculated intensity is not more than the threshold (NO in step S306), on the other hand, the real space marker processing unit 22 displays an instruction to continue to use the guide information on the user terminal 10 (step S307). In step S307, the real space marker processing unit 22 displays on the user terminal 10 a message saying “No region with necessary strength was detected. Please continue to use guide information”, for example.

When it is determined in step S302 or step S306 that the intensity is more than the threshold (YES in step S302 or step S306), the relevant region is usable as a real space marker. In this case, the real space marker processing unit 22 calculates misregistration between the guide information and the relevant region (step S308). In step S308, the real space marker processing unit 22 calculates misregistration in a three-dimensional space from the position of the center of the pasted guide information to the position of the center of the relevant region.

Next, the AR content target management unit 23 stores information about the relevant region in the AR content target management storage unit 24 as information about a real space marker (step S309).

In step S309, the AR content target management unit 23 acquires information about the relevant region, information on the correlation between the relevant region and the guide information, and information on the misregistration between the relevant region and the guide information from the real space marker processing unit 22. Then, the AR content target management unit 23 stores the acquired information in the AR content target management storage unit 24. The AR content display information indicated in FIG. 4B and the information associated with guide information indicated in FIG. 4C are updated through the process in step S309.

The information on the misregistration between the relevant region and the guide information is added to the list of AR content display information. In addition, the information about the relevant region correlated with the guide information is added to the list of information associated with guide information. The information about the relevant region is the real space marker information indicated in FIG. 4C, and information about feature points.

The specified relevant region and the AR content are associated with each other and the relevant region is registered as a real space marker through the processes described above. Since the real space marker is associated with the AR content, the AR content is displayed by recognizing the real space marker without pasting the guide information.

### <Recognition of Real Space Marker>

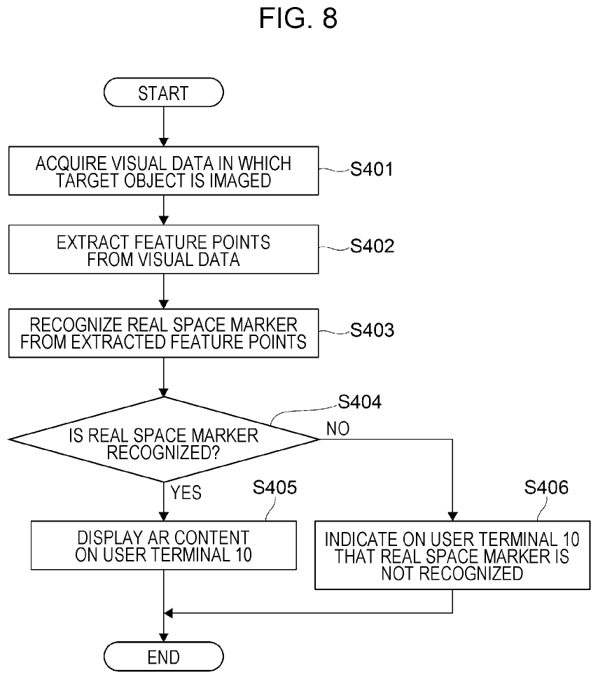

Next, a process of recognizing a real space marker will be described with reference to FIG. 8. FIG. 8 is a flowchart illustrating an example of the flow of a process of recognizing a real space marker.

In FIG. 8, first, the object recognition unit 21 acquires visual data in which a target object is imaged (step S401). In step S401, the object recognition unit 21 acquires visual data on a target object to which guide information is not pasted and which is imaged by the user terminal 10, for example.

Next, the object recognition unit 21 extracts feature points from the visual data (step S402). In step S402, the object recognition unit 21 performs a feature point extraction process in a range imaged in the visual data. Next, the real space marker processing unit 22 recognizes a real space marker from the extracted feature points (step S403). In step S403, the real space marker processing unit 22 acquires the real space marker information 114 (see FIG. 4C) stored in the AR content target management storage unit 24. Then, the real space marker processing unit 22 recognizes a real space marker by collating the extracted feature points and the information on the feature points stored in the AR content target management storage unit 24 as the real space marker information 114.

Next, the real space marker processing unit 22 determines whether or not a real space marker may be recognized (step S404). When a real space marker may be recognized (YES in step S404), the real space marker processing unit 22 displays an AR content on the user terminal 10 (step S405). A process executed to display an AR content in step S405 will be discussed in detail later.

When a real space marker may not be recognized (NO in step S404), on the other hand, the object recognition unit 21 indicates that a real space marker may not be recognized on the user terminal 10 (step S406). In step S406, the object recognition unit 21 displays on the user terminal 10 a message saying “No marker able to display AR content is recognized”, for example.

### <Display of AR Content>

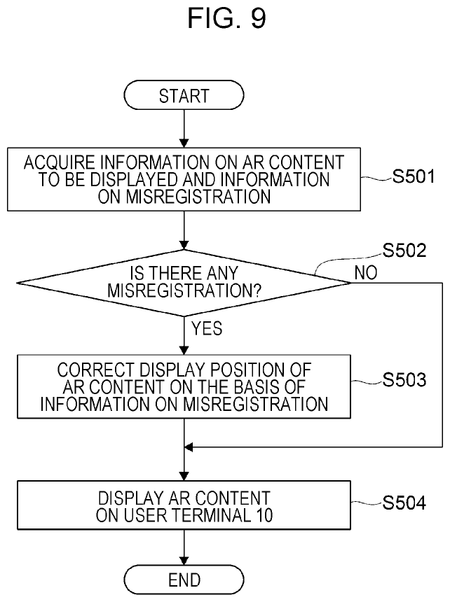

Next, a process executed to display an AR content in step S405 in FIG. 8 will be described with reference to FIG. 9. FIG. 9 is a flowchart illustrating an example of the flow of a process of displaying an AR content.

In FIG. 9, first, the real space marker processing unit 22 acquires information on an AR content to be displayed and information on misregistration (step S501). In step S501, the real space marker processing unit 22 requests information on an AR content to be displayed and information on misregistration from the AR content target management unit 23. The AR content target management unit 23 acquires such information from the AR content target management storage unit 24, and transmits the information to the real space marker processing unit 22.

Next, the real space marker processing unit 22 determines whether or not there is any misregistration (step S502). When there is no misregistration (NO in step S502), the process proceeds to step S504. When there is any misregistration (YES in step S502), on the other hand, the real space marker processing unit 22 corrects the display position of the AR content on the basis of the information on the misregistration (step S503). In step S503, the position at which the AR content is displayed is corrected on the basis of the misregistration between the position of the originally pasted guide information and the real space marker.

Then, the real space marker processing unit 22 displays the AR content on the user terminal 10 (step S504). In step S504, the real space marker processing unit 22 displays the AR content with the display position corrected when it is determined in step S502 that there is any misregistration. When it is determined in step S502 that there is no misregistration, on the other hand, the real space marker processing unit 22 displays the AR content at the original display position.

While an exemplary embodiment of the present disclosure has been described above, the technical scope of the present disclosure is not limited to the above exemplary embodiment described above. It is apparent from the following claims that a variety of modifications and improvements that may be made to the exemplary embodiment described above also fall within the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

An AR content display system comprising:
one or more processors configured to:
   acquire feature points in a nearby region in which guide information for displaying an AR content is pasted; and
   display the region in which the feature points are acquired and the AR content in association with each other.
      (((2)))

The AR content display system according to (((1))),
wherein the one or more processors are configured to specify a region with a large number of feature points from the nearby region, and associate the specified region and the AR content with each other.
   (((3)))

The AR content display system according to (((2))),
wherein the one or more processors are configured to calculate an intensity for evaluating the feature points in the specified region.
   (((4)))

The AR content display system according to (((3))),
wherein the one or more processors are configured to associate the specified region and the AR content with each other when the intensity is more than a threshold determined in advance.
   (((5)))

The AR content display system according to (((3))),
wherein the one or more processors are configured to suggest acquiring feature points again with the guide information removed when the intensity is less than a threshold determined in advance.
   (((6)))

The AR content display system according to (((5))),
wherein the one or more processors are configured to suggest using the guide information when the intensity of the feature points acquired again is less than the threshold determined in advance.
   (((7)))

The AR content display system according to (((1))),
wherein the one or more processors are configured to calculate misregistration between a position at which the guide information is pasted and a position in the region in which the feature points are acquired.
   (((8)))

The AR content display system according to (((1))),
wherein the one or more processors are configured to display the AR content associated with the region when the feature points in the region are detected, and correct a position at which the AR content is displayed on a basis of calculated misregistration.
   (((9)))

An AR content display system comprising
one or more processors configured to:
   recognize a region with feature points of a target object, an AR content for which is to be displayed, and display the AR content while correcting misregistration between a position of the region with the feature points and a position at which the AR content is to be displayed when the AR content is displayed on a basis of the recognized region with the feature points.
      (((10)))

A program causing one or more processors to execute a process comprising:
acquiring feature points in a nearby region in which guide information for displaying an AR content is pasted; and displaying the region in which the feature points are acquired and the AR content in association with each other.
   (((11)))

A program causing one or more processors to execute a process comprising:
recognizing a region with feature points of a target object, an AR content for which is to be displayed, and displaying the AR content while correcting misregistration between a position of the region with the feature points and a position at which the AR content is to be displayed when the AR content is displayed on a basis of the recognized region with the feature points.

What is claimed is:

1. An augmented reality (AR) content display system comprising:
one or more processors configured to:
acquire feature points in a nearby region in which guide information for displaying an AR content is pasted; and
display the region in which the feature points are acquired and the AR content in association with each other.

2. The AR content display system according to claim 1,
wherein the one or more processors are configured to specify a region with a large number of feature points from the nearby region, and associate the specified region and the AR content with each other.

3. The AR content display system according to claim 2,
wherein the one or more processors are configured to calculate an intensity for evaluating the feature points in the specified region.

4. The AR content display system according to claim 3,
wherein the one or more processors are configured to associate the specified region and the AR content with each other when the intensity is more than a threshold determined in advance.

5. The AR content display system according to claim 3,
wherein the one or more processors are configured to suggest acquiring feature points again with the guide information removed when the intensity is less than a threshold determined in advance.

6. The AR content display system according to claim 5,
wherein the one or more processors are configured to suggest using the guide information when the intensity of the feature points acquired again is less than the threshold determined in advance.

7. The AR content display system according to claim 1,
wherein the one or more processors are configured to calculate misregistration between a position at which the guide information is pasted and a position in the region in which the feature points are acquired.

8. The AR content display system according to claim 1,
wherein the one or more processors are configured to display the AR content associated with the region when the feature points in the region are detected, and correct a position at which the AR content is displayed on a basis of calculated misregistration.

9. A non-transitory computer readable medium storing a program causing one or more processors to execute a process comprising:
acquiring feature points in a nearby region in which guide information for displaying an AR content is pasted; and
displaying the region in which the feature points are acquired and the AR content in association with each other.

10. A non-transitory computer readable medium storing a program causing one or more processors to execute a process comprising:
recognizing a region with feature points of a target object, an AR content for which is to be displayed, and displaying the AR content while correcting misregistration between a position of the region with the feature points and a position at which the AR content is to be displayed when the AR content is displayed on a basis of the recognized region with the feature points.
